(19) United States
(12) Patent Application Publication
(10) Pub. No.: US 2014/0262661 A1
(43) Pub. Date: Sep. 18, 2014

(54) Wheel Assembly, Method, and Luggage

(71) Applicant: TRAVELPRO INTERNATIONAL, INC., Boca Raton, FL (US)

(72) Inventors: David L. Mathieu, Colchester, CT (US); James T. Sener, Glastonbury, CT (US)

(73) Assignee: TRAVELPRO INTERNATIONAL, INC., Boca Raton, FL (US)

(21) Appl. No.: 13/829,679

(22) Filed: Mar. 14, 2013

(51) Int. Cl. B60B 33/00; A45C 5/14

(52) U.S. Cl. CPC B60B 33/0007; A45C 5/14
USPC 190/18 A; 16/45; 16/46; 29/525.01

(57) ABSTRACT

A wheel assembly for luggage, a method of mounting the wheel assembly and a luggage are provided. The wheel assembly comprises a housing rotatably mountable to the wheel mount, a wheel rotatably mounted to the housing, and post connected to the housing. The method involves inserting a post into an opening of the wheel mount and securing the post to the wheel mount. The luggage includes a compartment for receiving articles, a chassis supporting the compartment and a wheel assembly.

### FIELD

The present specification relates generally to luggage and more specifically relates to a wheel assembly for luggage.

### BACKGROUND

In order to address the difficulties carrying luggage, wheeled luggage has been developed. Wheeled luggage refers to the various suitcases and baggage that employ wheeling devices, and allow users to roll their luggage instead of carry it. The wheeled luggage typically deploys a handle to aid in the transport and typically the luggage has a plurality of wheels integrated into the design. The wheels are features of the luggage and often support the weight of the luggage and rotate so as to allow the luggage to be rolled in any desired direction.

### SUMMARY

In accordance with an aspect of the specification, there is provided a wheel assembly for luggage having a wheel mount. The wheel assembly includes a housing rotatably mountable to the wheel mount. The housing is configured to rotate about a first axis. The wheel assembly also includes a wheel rotatably mounted to the housing. The wheel is configured to roll along a surface. The wheel is rotatable about a second axis. The second axis is substantially perpendicular to the first axis. The wheel assembly further includes a post having a first end and a second end opposite the first end. The first end is connected to the housing. The second end is configured to extend through and beyond an opening in the wheel mount when the wheel assembly is subjected to a load.

The wheel assembly may further include a fastener for securing the post to the wheel mount.

The wheel mount and the fastener may form a gap therebetween when the wheel assembly is subjected to the load. The gap may be configured to provide rotational freedom of the housing about the first axis.

The fastener may be a screw.

The screw may include a head. The head may have a dimension greater than the opening.

The wheel assembly may further include a member disposed at the second end of the post. The member may be configured to engage the fastener and the post. The member may have a dimension greater than the opening and the member configured to secure the post to the wheel mount

The member may be a washer.

The wheel mount and the member may form a gap therebetween when the wheel assembly is subjected to the load. The gap may be configured to provide rotational freedom of the housing about the first axis.

The wheel assembly may further include a bearing assembly disposed between the housing and the wheel mount. The bearing assembly may be for reducing friction during rotation about the first axis.

The bearing assembly may include a rolling element, a first race and a second race.

The bearing assembly may be configured to transition between an unloaded state and a loaded state. The unloaded state may have the rolling element disposed loosely between the first race and the second race. The loaded state may have the rolling element compressed between the first race and the second race.

The loaded state of the bearing may allow for the post to extend further beyond the opening.

The housing may be compressible and the housing may be configured to transition between an unloaded state and a loaded state. The loaded state of the housing may allow for the post to extend further beyond the opening in the wheel mount.

In accordance with another aspect of the specification, there is provided a method of mounting a wheel assembly to a wheel mount of luggage. The method involves inserting a post of the wheel assembly into an opening of the wheel mount. An end of the post is configured to extend through and beyond the wheel mount when the wheel assembly is subjected to a load. The method may also involve securing the post to the wheel mount with a fastener, the wheel mount rotatable about a first axis.

Securing may involve providing a gap between the wheel mount and the fastener when the wheel assembly is subjected to the load. The gap may be configured to provide rotational freedom of the wheel assembly about the first axis.

Securing with the fastener may involve using a screw having a head with a dimension greater than the opening.

Securing with the fastener may involve engaging a member with the fastener. The member may have a dimension greater than the opening.

Securing may involve providing a gap between the wheel mount and the member when the wheel assembly is subjected to the load. The gap configured to provide rotational freedom of the wheel assembly about the first axis.

In accordance with another aspect of the specification, there is provided a luggage. The luggage includes a compartment for receiving articles. The luggage also includes a chassis supporting the compartment, the chassis having a wheel mount. Furthermore, the luggage includes a wheel assembly. The wheel assembly includes a housing rotatably mountable to the wheel mount. The housing configured to rotate about a first axis. The wheel assembly also includes a wheel rotatably mounted to the housing. The wheel is configured to roll along a surface. The wheel is rotatable about a second axis substantially perpendicular to the first axis. The wheel assembly further includes a post having a first end and a second end opposite the first end. The first end is connected to the housing. The second end is configured to extend through and beyond an opening in the wheel mount when a load is applied to the wheel assembly. a fastener for securing the post to the wheel mount. The wheel assembly also includes a fastener for securing the post to the wheel mount.

The wheel assembly may further include a member disposable at the second end of the post. The member may be configured to engage the fastener and the post. The member may have a dimension greater than the opening and the member configured to secure the post to the wheel mount.

### BRIEF DESCRIPTION OF THE DRAWINGS

Reference will now be made, by way of example only, to the accompanying drawings in which:

FIG. 1 is a perspective view of a luggage in accordance with an embodiment;

FIG. 2 is another perspective view of the luggage shown in accordance with the embodiment of FIG. 1;

FIG. 3 is a perspective view of a wheel assembly in accordance with an embodiment;

FIG. 4 is a cross sectional view showing a bearing assembly in the wheel assembly in accordance with the embodiment of FIG. 3;

FIG. 5 is a side view of a first state of the wheel assembly in accordance with the embodiment of FIG. 3 and a wheel mount;

FIG. 6 is a cross sectional view of the wheel assembly and the wheel mount shown in FIG. 5;

FIG. 7 is a zoomed in view of the area VI of FIG. 6;

FIG. 8 is a side view of a second state of the wheel assembly in accordance with the embodiment of FIG. 3 and a wheel mount;

FIG. 9 is a cross sectional view of the wheel assembly and the wheel mount shown in FIG. 5;

FIG. 10 is a zoomed in view of the area X of FIG. 6;

FIG. 11 is a zoomed in view of the area X of FIG. 6 when overtorqued;

FIG. 12 is a right side view of the wheel assembly in accordance with the embodiment of FIG. 3;

FIG. 13 is a left side view of the wheel assembly in accordance with the embodiment of FIG. 3;

FIG. 14 is a rear view of the wheel assembly in accordance with the embodiment of FIG. 3;

FIG. 15 is a front view of the wheel assembly in accordance with the embodiment of FIG. 3;

FIG. 16 is a top view of the wheel assembly in accordance with the embodiment of FIG. 3;

FIG. 17 is a bottom view of the wheel assembly in accordance with the embodiment of FIG. 3;

FIG. 18 is a perspective view of a wheel assembly in accordance with another embodiment;

FIG. 19 is a right side view of the wheel assembly in accordance with the embodiment of FIG. 18;

FIG. 20 is a left side view of the wheel assembly in accordance with the embodiment of FIG. 18;

FIG. 21 is a rear view of the wheel assembly in accordance with the embodiment of FIG. 18;

FIG. 22 is a front view of the wheel assembly in accordance with the embodiment of FIG. 18;

FIG. 23 is a top view of the wheel assembly in accordance with the embodiment of FIG. 18; and

FIG. 24 is a bottom view of the wheel assembly in accordance with the embodiment of FIG. 18.

### DETAILED DESCRIPTION OF THE EMBODIMENTS

As used herein, any usage of terms that suggest an absolute orientation (e.g. “top”, “bottom”, “front”, “back”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

Referring now to FIG. 1, luggage is indicated generally at 50. In a non-limiting example embodiment, the luggage 50 includes a compartment 54 supported by a chassis 56 for storing and transporting personal effects or other articles. The luggage 50 also includes a plurality of wheel assemblies 58-1, 58-2, 58-3 and 58-4. (Collectively, wheel assemblies 58, and generically, wheel assembly 58. This nomenclature is used elsewhere herein.) The wheel assemblies 58 are mounted to compartment 54, and can be used to roll the luggage 50 along a substantially smooth surface. Although the present embodiment discloses four wheel assemblies 58-1, 58-2, 58-3 and 58-4, it is to be re-emphasized that the present embodiment is not particularly limited and that the luggage 50 can be modified to include more or less than four wheel assemblies.

In the present embodiment, the luggage 50 also includes a handle 62 that connects to compartment 54 via a pair of retractable rods 66. In FIG. 1, the retractable rods 66 are in a fully extended position so that handle 62 is brought within an arm's reach while a person is standing substantially upright. It is to be understood that the retractable rods 66 are movable between the extended position shown in FIG. 1 and a retracted position within a recessed chamber (not shown) disposed within a side of compartment 54 that is opposite from the side of compartment 54 to which wheel assemblies 58 are mounted in the present embodiment.

It is to be re-emphasized that the structure shown in FIG. 1 is a non-limiting representation only. It is to be understood that the handle 62 and the retractable rods 66 are not particularly limited and that several different configurations are contemplated. For example, the pair of retractable rods 66 can be modified to be a single retractable rod. As another example, the retractable rods 66 need not be retractable and can be modified to be foldable or removeable from the luggage 50.

Referring again to FIG. 1, in a present embodiment, the compartment 54 can be opened to receive or remove articles, and can be closed for storage or transportation. It is to be understood that the nature of compartment 54 is not particularly limited, and that variations on the configuration of the compartment 54 are contemplated. For example, the compartment 54 can be of a hard material (e.g. plastic or metal) or a soft material (e.g. fabric). The compartment 54 can also have different configurations, including a split configuration comprising two equal size portions or non-equal size portions. The compartment 54 can be a backpack, dufflebag, carrying case, purse, computer case or transporter, briefcase, or any type of bag or transporter having wheels. The compartment 54 can also be configured to open from one or more different sides, and the means by which it is opened is not particularly limited. Likewise the configuration, orientation and type of hinging mechanism (not shown) are not particularly limited. A variety of other types of compartments will now occur to those skilled in the art.

In the present embodiment, the compartment 54 is supported by the chassis 56 and the chassis 56 includes a plurality of wheel mounts 57-1, 57-2, 57-3, and 57-4. The corners are connected using rigid members (not shown) to maintain the shape of the luggage 50. It is to be appreciated that the exact configuration of the chassis 56 is not particularly limited and that several variations are contemplated. For example, the chassis 56 can be modified to be a unitary rigid frame. Alternatively, the chassis 56 can also be modified to be a solid shell to form the compartment 54. In other embodiments, the chassis 56 can be semi-rigid and/or collapsible. It is to be understood that the chassis 56 is not particularly limited to any material and that several different types of materials are contemplated such as materials which have mechanical properties appropriate for supporting the compartment 54. Some examples of suitable materials include metals, plastics, composites and other materials commonly used for luggage frames.

In a present embodiment, four wheel assemblies 58 are provided. As shown in FIG. 1, each wheel assembly can rotate along a rotational axis 74 that is substantially parallel to a surface so that the luggage 50 can be rolled in direction “A” in reaction to a force applied along the direction “B” to the handle 62. The wheel assemblies 58 are also configured to rotate about an axis 78 that is perpendicular to the surface to thereby change the orientation of rotational axis 74 so that the luggage 50 can be rolled in any direction along the surface. To illustrate this point, in FIG. 2 the luggage 50 is shown as being moved in direction “C” (approximately perpendicular to direction “A” in FIG. 1) in reaction to force applied in an approximately perpendicular direction “D” on the handle 62 such that wheel assemblies 58 rotate initially rotate about each rotational axis 78 approximately 90 degrees and subsequently rotate about each rotational axis 74 to move the luggage 50.

It is to be re-emphasized that the structure shown in FIGS. 1 and 2 is a non-limiting representation only. Notwithstanding the specific example, it is to be understood that the number and nature of wheel assemblies 58 is not particularly limited. For example, fewer or more wheel assemblies 58 can be provided. In other configurations, one or more of the wheel assemblies 58 can be configured to rotate, or not, about the axis 78, while one or more of the wheel assemblies 58 are modified to be fixed with respect to the axis 78.

Referring now to FIG. 3, a wheel assembly 58 is shown in greater detail. It is to be understood that the wheel assembly 58 shown in the present embodiment is purely exemplary and it will be apparent to those skilled in the art that a variety of wheel assemblies are contemplated including other embodiments discussed in greater detail below. The wheel assembly 58 includes a housing 100, a wheel 104, a post 108, a bearing assembly 124, and a member 112.

It is to be re-emphasized that the structure of the wheel assembly 58 is not particularly limited and that variations are contemplated. For example, although the wheel assembly 58 of the present embodiment shows a single wheel 104 in a housing 100 between a fork, other structures are contemplated. For example, the wheel assembly 58 can be modified to include more than a single wheel connected by an axle. Alternatively, the wheel assembly 58 can be further modified to include a plurality of wheels, each with their own axle.

In the present embodiment, the housing 100 is rotatably mountable to the luggage 50 to provide rotation about the axis 78. The manner by which the housing 100 rotates about the axis 78 is not particularly limited. In the present embodiment, a bearing assembly 124 is used to provide rotation about the axis 78. In other embodiments, the housing 100 can be configured to fit within an opening in the luggage 50 such that the fit provides for rotational movement. The housing 100 is typically constructed from materials which can support the weight of the luggage 50. Some examples of suitable materials include plastics, metals, composites, and other materials commonly used for wheel assemblies.

The wheel 104 is rotatably mounted to the housing 100 and can be rotated about the axis 74. The wheel 104 is generally configured to roll along a surface to move the luggage 50 along a surface. The manner by which the wheel 104 rotates about the axis 74 is not particularly limited. In the present embodiment, the wheel 104 is mounted to the housing 100 with a bearing assembly. In other embodiments, the wheel 104 can be mounted using other types of bearings such as plain bearings, roller bearings, fluid bearings, or magnetic bearings. In further embodiments, the bearing assembly 124 can be omitted completely if an alternative mechanism for providing rotational motion is substituted. It is also to be understood that the wheel 104 is not particularly limited to any material and that several different types of materials are contemplated. A suitable material for a wheel is generally a durable material that is resiliently deformable such that the wheel can absorb vibrations from rolling without excessive wear. Examples of such materials include rubber, silicone, and plastic.

The post 108 is connected to the housing 100 and extends from the housing 100 to engage the luggage 50. In the present embodiment, the post 108 is cylindrical in shape connected to the housing 100 at one end, and configured to receive a fastener 116 at the other end. In the present embodiment, the central axis of the post 108 coincides with the axis 78. It is to be appreciated that the post 108 is configured to extend from the housing 100 through an opening of the wheel mount 57 where the fastener 116 secures the post 108. The manner by which the post 108 is connected to the housing 100 as well as the manner by which the post 108 is secured to the luggage 50 is not particularly limited. As discussed above, in the present embodiment, the post 108 is inserted into the wheel mount 57 through an opening and secured with the fastener 116. The bearing assembly 124 provides for rotational movement of the wheel assembly about the axis 78.

In the present embodiment, the post 108 is configured to extend beyond the wheel mount 57 when the wheel assembly 58 is subjected to a load, which will be discussed in greater detail below. It is to be re-emphasized that the present embodiment is a non-limiting representation only, and that variations are contemplated. For example, when the wheel assembly 58 is not subjected to a load, the post 108 can extend beyond the wheel mount 57 in some embodiments, and not extend beyond the wheel mount 57 in other embodiments. As another example, in some embodiments, the post 108 may not extend beyond the wheel mount 57 when the wheel assembly 58 is subjected to a load. In such embodiments, the force of friction acting against the rotation of wheel mount 57 about the axis 78 can be reduced by reducing the amount of normal force applied to the wheel mount 57 by the fastener 116.

The post 108 is typically constructed from materials which are rigid and which can withstand the forces associated with moving the luggage 50. Some examples of suitable materials include plastics, metals, composites, and other materials.

In the present embodiment, the bearing assembly 124 is disposed between the housing 100 and the wheel mount 57. The bearing assembly 124 is generally configured to reduce friction during rotational motion of the housing 100 about the axis 78. The manner by which the bearing assembly 124 reduces friction is not particularly limited. In the present embodiment as shown in greater detail in FIG. 4, the bearing assembly 124 includes a rolling element 128, a first race 132 and a second race 136. The first race 132 and the second race 136 include a track for the rolling element 128. The housing 100 includes a tab 140 configured to engage the first race 132 to hold the bearing assembly within the housing 100. It is to be appreciated, with the benefit of this description, that the bearing assembly 124 is optional and that other ways to reduce friction between the wheel assembly 58 and the wheel mount 57 are contemplated. For example, a smooth surface configured to allow sliding can be used.

The member 112 is generally configured to be disposed at the end of the post 108 and is generally configured to engage the fastener 116. In the present embodiment, the member 112 has a dimension greater than the opening of the wheel mount 57. By engaging the fastener 116, the member 112 engages the post 108 to secure the post 108 to the wheel mount 57. In addition, since the member 112 engages the post 108 instead of the wheel mount 57, the member 112 allows for rotational of the housing 100 about the axis 78. In this present embodiment, the rotational freedom is maintained by reducing the extent by which the member 112 frictionally engages the mount 57. It is to be understood that any frictional engagement can reduce the rotational freedom of the housing 100, especially when overtorquing the fastener 116.

It is to be appreciated, with the benefit of this description, that the member 112 is optional and can be included as part of the wheel assembly 58 or as a separate component which can be obtained from another manufacturer. In the present embodiment, the member 112 is generally included as part of the wheel assembly 58 for use to mount the wheel assembly 58 to the wheel mount 57.

The structure of the member 112 is also not particularly limited and can include several different structures. In the present embodiment, the member 112 is a washer; however, in other embodiments, the member 112 can be modified to be a clip or other structure capable of securing the housing 100 to the wheel mount 57. In other embodiments, the member 112 can be integrally formed on the post or the fastener 116, for example, if the wheel mount is configured to wrap around the post 108 between the member 112 and the housing 100. Alternatively, the member 112 can be omitted, for example, if the fastener 116 is greater in diameter than the post 108 to secure the housing 100 to the wheel mount 57. It is also to be understood that the member 112 is not particularly limited to any material and that several different types of materials are contemplated including plastics, metals, composites, and other materials.

The fastener 116 is generally configured secure the post 108 to the wheel mount 57. It is to be appreciated that the fastener 116 is not particularly limited and can include various types of fasteners capable of securing the post 108 to the wheel mount 57. In the present the fastener 116 is a screw for engaging the member 112. In other embodiments, the fastener 116 can be a bolt, nail, or other type of fasteners capable of securing the post 108 to the wheel mount 57. It is to be appreciated that in embodiments where the fastener 116 includes a head having a dimension greater than the opening of the wheel mount 57, the fastener 116 can be used to directly secure the post 108 to the wheel mount 57 and the member 112 can be omitted. Furthermore, the fastener 116 can be included as part of the wheel assembly 58 during manufacture or can be an additional component obtained from another source.

Referring to FIGS. 5 and 6, the wheel assembly 58 is shown in an unloaded state. The post 108 is generally configured to extend through the wheel mount 57 such that the member 112 can be fastened to the end of the post 108. It is to be appreciated, with the benefit of this specification, that the member 112 is configured to engage with the wheel mount 57 to prevent the wheel assembly 58 from falling out of the wheel mount 57 when there is no load on the wheel assembly 58.

As shown in FIG. 6, the bearing assembly 124 in the unloaded state includes the rolling element 128 disposed loosely between the first race 132 and the second race 136. It is to be appreciated, with the benefit of this description, that the bearing assembly 124 is not particularly limited and need not be loose as shown in FIG. 6 and can even be omitted. In other embodiments, the housing 100 can be compressible or resiliently deformable such that the housing 100 is in the uncompressed state when the wheel assembly 58 is in the unloaded state.

Referring to FIG. 7, a schematic representation of the area VII of FIG. 6 is shown to illustrate the member 112 engaging the wheel mount 57 in greater detail. In the present embodiment, the member 112 is configured to overlap the wheel mount 57 for securing the wheel assembly 58 within the wheel mount 57.

Referring to FIGS. 8 and 9, the wheel assembly is shown in a loaded state where a load applies a downward force on the wheel assemblies 58 shown in the orientation illustrated in FIGS. 8 and 9. The post 108 is generally configured to extend through and beyond the wheel mount 57 such that a gap 126 is formed above the surface of the wheel mount as shown in FIGS. 8 and 9. In the present embodiment, the gap 126 is formed between the wheel mount 57 and the member 112. However, in other embodiments, such as those without a member, the gap 126 can be formed between the wheel mount 57 and the component used to secure the post 108, for example, the fastener 116.

As shown in FIG. 9, the bearing assembly 124 in the loaded state includes the rolling element 128 compressed between the first race 132 and the second race 136. It is to be appreciated, with the benefit of this description, that the bearing assembly 124 is not particularly limited and can even be omitted. In other embodiments, the housing 100 can be compressible or resiliently deformable such that the housing 100 is in the compressed state when the wheel assembly 58 is in the unloaded state.

It is to be understood that the gap 126 arises from the application of a load force on the components of the wheel assembly 58 such that the load removes the smaller gaps from wheel assembly 58 or compresses the housing 100 causing the post 108 to be urged further through and/or beyond the opening of the wheel mount 57. For example, the bearing assembly 124 can include gaps between a rolling element 128 and a first race 132 as well as the rolling element 128 and a second race 136 as shown in FIG. 6. When a force from a load is applied to the bearing assembly 124, the bearing assembly 124 transitions from the unloaded state to the loaded state by eliminating the gaps. By forming the gap 126 between the wheel mount 57 and the member 112, frictional forces between the wheel mount 57 and the wheel assembly 58 are reduced. Accordingly, it is to be appreciated, with the benefit of this description, that the gap 126 provides rotational freedom to the housing 100 about the axis 78.

In the present embodiment, the gap 126 reduces the frictional force, which ultimately inhibits the rotation of the wheel assembly 58 about the axis 78, between the member 112 and the wheel mount 57. In the present embodiment, the gap 126 is approximately 15 thou. It is to be appreciated that the size of the gap 126 is not particularly limited and is dependent on predetermined tolerances of the wheel assembly 58 based on manufacturing considerations as well as the typical load placed on the wheel assembly 58. For example, the gap 126 can be smaller or larger than 15 thou. In other embodiments, the gap 126 can be as small as 5 thou. In further embodiments still, the gap 126 can be modified to be smaller than 5 thou. It is to be appreciated, with the benefit of this description if the gap 126 is reduced, the housing 100 can be more tightly mounted to the wheel mount 57 for reducing the amount of wiggle. Therefore, a smaller gap 126 generally increases the stability of the luggage 50. However, reducing the gap 126 also is associated with a reduction in an acceptable tolerance which can increase the cost of manufacturing.

Referring to FIG. 10, a schematic representation of the area X of FIG. 9 is shown and illustrates the gap 126 in greater detail. It is to be appreciated that by extending the post 108 beyond the wheel mount 57, the gap 126 spaces the member 112 away from the wheel mount 57 to reduce contact and in turn, reduce the frictional forces between the member 112 and the wheel mount 57. Therefore, the post 108, the member 112 and the fastener 116 are free to rotate about the axis 78 with little or no frictional force when the fastener 116 is overtorqued.

Referring to FIG. 11, a schematic representation of the area indicated in the area X of FIG. 9 illustrates the gap 126 in greater detail when the fastener 116 is overtorqued on the post 108. Under this overtorqued state, the fastener 116 applies a large amount of force on a portion of the member 112 under the fastener 116. The force can cause the portion of the member 112 under the fastener 116 to deform in a direction toward the post 108 while the post 108 can apply an opposite force to cause a portion of the member 112 over the post by not under the fastener. In the illustrated example, it is to be appreciated that these opposing forces cause the member 112 to bend away from the wheel mount 57 as shown in FIG. 8. It is to be appreciated that the bending of the member 112 as shown moves the member 112 away from the wheel mount 57 to maintain the gap 126 when the fastener 116 is overtorqued. Therefore, when the fastener 116 is in an overtorqued state in the present embodiment, no additional frictional force is applied between the member 112 and the wheel mount 57 and the rotational freedom about the axis 78 is preserved.

It is to be re-emphasized that the structure shown in FIGS. 3 to 8 is a non-limiting representation only. Notwithstanding the specific example, it is to be understood that other mechanically equivalent structures and wheel assemblies can be devised to perform the same function as the wheel assembly 58.

As an example of a variation, the post 108 can be mounted to the housing 100 with a bearing assembly disposed between the post 108 and the luggage 50. In other embodiments, the bearing assembly 124 can be modified to be any other type of bearing such as a plain bearing, a roller bearing, a fluid bearing, or a magnetic bearing. As another variation, it is also to be understood that the wheel assembly 58 can be modified so that the bearing is disposed within the post 108. Alternatively, the bearing assembly 124 can be omitted completely if and the post 108 can be allowed to rotate sufficiently freely relative to the luggage 50 to provide for easy steering during use.

Various advantages will now be apparent. Of note is the increase of the tolerances associated with servicing the wheel assembly 58 on the luggage 50 such as installation or replacement. In general, overtorquing the fastener 116 can result in failure of the wheel assembly 58. In particular, it is to be appreciated that overtorquing can result in the increase of frictional forces between the rotating portions of the wheel assembly 58 and the luggage 50. The overtorquing can cause the post 108 and/or the housing 100 to deform, resulting in a reduced ability to rotate about the axis 78. In addition, overtorquing can result in damage to the post 108 and the fastener 116 such as stripping of thread. By increasing the tolerances, it is to be appreciated that probability of problems associated with overtorquing the fastener are reduced. Therefore, the replacement of the wheel assembly 58 can be carried out under more conditions such as with less skilled technicians.

Another advantage, which will also be apparent to a person of skill in the art, is that the installation of the wheel assembly 58 can now be easily completed by tightening the fastener 116 using much larger torques for consistency in the manufacture of the luggage 50 as well as the repair of luggage 50. Accordingly, this reduces the need for accurately measuring the torque applied to the fastener 116 or loosening a tightened fastener 116 to ensure rotational freedom.

FIGS. 12 to 17 show other views of the present embodiment to aid in the understanding of the present embodiment.

Referring to FIG. 18, another embodiment of a wheel assembly 58a is shown in greater detail. Like components of the wheel assembly 58a bear like reference to their counterparts in the wheel assembly 58, except followed by the suffix “a”. The wheel assembly 58a is configured to be rotatable about an axis 78a. The wheel assembly 58a includes a housing 100a, a first wheel 104a-1, a second wheel 104a-2, a post 108a, a bearing assembly 124a, and a member 112a. The post 108a is configured to receive a fastener 116a.

FIGS. 19 to 24 show other views of the embodiment shown in FIG. 18 to aid in the understanding of the embodiment.

While specific embodiments have been described and illustrated, such embodiments should be considered illustrative only and should not serve to limit the accompanying claims.

Further variations, combinations, and subsets of the foregoing will now occur to those skilled in the art.

What is claimed is:

1. A wheel assembly for luggage having a wheel mount, the wheel assembly comprising:
a housing rotatably mountable to the wheel mount, the housing configured to rotate about a first axis;
a wheel rotatably mounted to the housing, the wheel configured to roll along a surface, the wheel rotatable about a second axis, the second axis substantially perpendicular to the first axis; and
a post having a first end connected to the housing, and a second end opposite the first end, the second end configured to extend through and beyond an opening in the wheel mount when the wheel assembly is subjected to a load.

2. The wheel assembly of claim 1, further comprising a fastener for securing the post to the wheel mount.

3. The wheel assembly of claim 2, wherein the wheel mount and the fastener form a gap therebetween when the wheel assembly is subjected to the load, the gap configured to provide rotational freedom of the housing about the first axis.

4. The wheel assembly of claim 3, wherein the fastener is a screw.

5. The wheel assembly of claim 4, wherein the screw includes a head, the head having a dimension greater than the opening.

6. The wheel assembly of claim 2, further comprising a member disposed at the second end of the post, the member configured to engage the fastener and the post, the member having a dimension greater than the opening and the member configured to secure the post to the wheel mount.

7. The wheel assembly of claim 6, wherein the member is a washer.

8. The wheel assembly of claim 6, wherein the wheel mount and the member form a gap therebetween when the wheel assembly is subjected to the load, the gap configured to provide rotational freedom of the housing about the first axis.

9. The wheel assembly of claim 1, further comprising a bearing assembly disposed between the housing and the wheel mount, the bearing assembly for reducing friction during rotation about the first axis.

10. The wheel assembly of claim 9, wherein the bearing assembly includes a rolling element, a first race and a second race.

11. The wheel assembly of claim 10, wherein the bearing assembly is configured to transition between an unloaded state and a loaded state, the unloaded state having the rolling element disposed loosely between the first race and the second race, the loaded state having the rolling element compressed between the first race and the second race.

12. The wheel assembly of claim 11, wherein the loaded state of the bearing allows for the post to extend further beyond the opening.

13. The wheel assembly of claim 1, wherein the housing is compressible and the housing is configured to transition between an unloaded state and a loaded state, wherein the loaded state of the housing allows for the post to extend further beyond the opening in the wheel mount.

14. A method of mounting a wheel assembly to a wheel mount of luggage, the method comprising:
inserting a post of the wheel assembly into an opening of the wheel mount, an end of the post configured to extend through and beyond the wheel mount when the wheel assembly is subjected to a load; and
securing the post to the wheel mount with a fastener, the wheel mount rotatable about a first axis.

15. The method of claim 14, wherein securing comprises providing a gap between the wheel mount and the fastener when the wheel assembly is subjected to the load, the gap configured to provide rotational freedom of the wheel assembly about the first axis.

16. The method of claim 14, wherein securing with the fastener comprises using a screw having a head with a dimension greater than the opening.

17. The method of claim 14, wherein securing with the fastener comprises engaging a member with the fastener, the member having a dimension greater than the opening.

18. The method of claim 17, wherein securing comprises providing a gap between the wheel mount and the member when the wheel assembly is subjected to the load, the gap configured to provide rotational freedom of the wheel assembly about the first axis.

19. A luggage comprising:
a compartment for receiving articles;
a chassis supporting the compartment, the chassis having a wheel mount; and
a wheel assembly comprising:
a housing rotatably mountable to the wheel mount, the housing configured to rotate about a first axis;
a wheel rotatably mounted to the housing, the wheel configured to roll along a surface, the wheel rotatable about a second axis, the second axis substantially perpendicular to the first axis;
a post having a first end connected to the housing, and a second end opposite the first end, the second end configured to extend through and beyond an opening in the wheel mount when a load is applied to the wheel assembly; and
a fastener for securing the post to the wheel mount.

20. The luggage of claim 19, wherein the wheel assembly further comprises a member disposable at the second end of the post, the member configured to engage the fastener and the post, the member having a dimension greater than the opening and the member configured to secure the post to the wheel mount.
